(19) United States
(12) Patent Application Publication
(10) Pub. No.: US 2003/0117563 A1
(43) Pub. Date: Jun. 26, 2003

(54) Portable information terminal using liquid crystal display

(76) Inventor: Joo Soo Lim, Kumi-shi (KR)

Correspondence Address: SONG K. JUNG, McKenna Long & Aldridge LLP, 1900 K Street, NW, Washington, DC, 20006, US

(21) Appl. No.: 10/293,598

(22) Filed: Nov. 14, 2002

(30) Foreign Application Priority Data
Dec. 22, 2001 (KR) 2001-83243

(51) Int. Cl. G02F 1/1345

(52) U.S. Cl. 349/149

(57) ABSTRACT

A portable information terminal incorporating a liquid crystal display includes a data pad formed at a middle portion of a lower region of a liquid crystal display panel and connected to each data line of the liquid crystal display panel; and gate pads arranged adjacent opposite portions of the data pad and connected to each gate line of the liquid crystal display panel.

This application claims the benefit of Korean Patent Application No. 2001-83243, filed on Dec. 22, 2001, which is hereby incorporated by reference for all purposes as if fully set forth herein.

### BACKGROUND OF THE INVENTION

1. Field of the Invention

The present invention relates to portable information terminals incorporating liquid crystal displays, and more particularly to portable information terminals of reduced size incorporating liquid crystal displays.

2. Discussion of the Related Art

As portable information terminals such as mobile communication terminals (e.g., mobile phones, personal communication system PCS, etc.), portable digital apparatuses (PDAs), hand held PCs (HPCs), real-time motion picture information systems (e.g., IMT-2000, etc.), etc., continue to be developed, their size continues to be reduced. Accordingly, liquid crystal display (LCD) modules typically included within portable information terminals to display pictures, are also being reduced in size.

Referring to FIG. 1, LCD modules include a liquid crystal display panel 11, a gate pad group 14 and data pad group 16 formed laterally adjacent each other at a lower portion of the liquid crystal display panel 11, a plurality of gate driving integrated circuits (ICs) 22 and a plurality of data driving ICs 24 mounted on a flexible printed circuit (FPC) film 18, and an FPC film 26 connecting the FPC film 18 to a main board 30.

Within the liquid crystal display panel 11, a plurality of liquid crystal cells are. arranged in a matrix pattern at crossings of a plurality of gate lines (GL) and data lines (DL). A layer of liquid crystal material is provided between an upper substrate bonded to a lower substrate (not shown). The upper substrate may support a sequentially formed color filter, a common electrode, and an alignment film. The lower substrate 12 may support sequentially formed thin film transistors TFTs, pixel electrodes, and an alignment film.

The gate and data pad groups 14 and 16, respectively, are provided laterally adjacent each other at a lower portion of the liquid crystal display panel 11. The gate pads within the gate pad group 14 are provided at the lower-left portion of the liquid crystal display panel 11 and are connected to corresponding gate lines (GL) via a gate link (GK). The gate link (GK) includes a conductive line pattern formed by the deposition and patterning (via photolithography) of metal material as the metal material is also deposited and patterned to form the gate pads and gate lines (GL).

The data pad within the data pad group 16 are arranged at the lower-right portion of the liquid crystal display panel 11, adjacent the gate pad group 14, and are connected to corresponding data lines (DL) via a data link (DK). The data link (DK) includes a conductive line pattern formed by the deposition and patterning (via photolithography) of metal material as the metal material is also deposited and patterned to form the data pads and data lines (DL).

The FPC film 18 includes output pads that are coupled to the gate and data pads within the gate and data pad groups 14 and 16, respectively, using an anisotropic conductive film ACF. The gate and data driving ICs 22 and 24, respectively, are mounted on the FPC film 18 using a chip-on-film (COF) technique.

The gate driving ICs 22 generate scanning signals that are supplied to the gate lines (GL) via the output pads and the gate pads within the gate pad group 14. Accordingly, the liquid crystal display panel 11 is sequentially scanned by the scanning signals, one gate line at a time.

The data driving ICs 24 supply video data signals to the data lines (DL) one data line at a time. Accordingly, a liquid crystal pixel cell connected to a scanned gate line is charged with the video data.

A timing controller (not shown), for controlling the gate and data driving ICs 22 and 24, respectively, can be mounted on FPC film 18. The timing controller includes a shift register for supplying gate start pulses to each of the gate driving ICs 22 and red (R), green (G), and blue (B) data and clock signals to each of the data driving ICs 24.

The FPC film 26 includes a signal transmission path, through which signals are transmitted between the main board 30 and the driving FPC film 18. A connector 28 connects one end of the FPC film 26 to a connection jack of the main board 30.

The main board 30 includes a microprocessor and a graphic processing circuit for transmitting video data and control signals through the FPC film 26.

Referring to FIG. 1, because each of the gate and data pad groups 14 and 16, respectively, are formed laterally adjacent each other, the gate link (GK) has a width A. As the resolution of the liquid crystal panel 11 increases, the number of gate lines GL increases. Along with the increase in gate lines GL, the width A of the gate link GK increases. An increase in the width A of the. gate link GK at the right edge of the liquid crystal display panel 11 becomes problematic as the size of LCD modules incorporated within portable information terminals continue to decrease.

Furthermore, for a gate link GK of any width, the length of each line pattern connecting a gate pad to a corresponding gate line depends on its position within the gate link GK and resistance values of various line patterns within the gate link GK differ from each other. For example, the difference in resistance between the longest line pattern and the shortest line pattern in the gate link GK is 1 kΩ or more. Due to the length dependent resistance differences in the line patterns, different bias voltages must be applied to each of the gate pads within the gate pad group 14 and scanning signals applied to the individual gate lines GL become distorted, thereby degrading the quality of any pictures displayed by the LCD module.

As illustrated in FIG. 2, degradation of picture quality may be caused by similar problems encountered by length dependant resistance properties induced by different line patterns within the width A of the data link DK.

### SUMMARY OF THE INVENTION

Accordingly, the present invention is directed to a portable information terminal incorporating a liquid crystal display that substantially obviates one or more of the problems due to limitations and disadvantages of the related art.

Accordingly, an advantage of the present invention provides a portable information terminal using a liquid crystal display suitable for a small portable information device and capable of preventing deterioration in picture quality.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

In order to achieve these and other advantages of the invention, a portable information terminal incorporating a liquid crystal display according to one aspect of the present invention may include a data pad group arranged at a middle portion of an edge of a liquid crystal display panel, wherein the data pads within the data pad group are connected to data lines of the liquid crystal display panel, and gate pad groups formed adjacent opposite portions of the data pad group, wherein gate pads within the gate pad group are connected to gate lines of the liquid crystal display panel.

In one aspect of the present invention, the portable information terminal may further include a data driving IC for supplying video data to drive the data lines, a gate driving IC arranged vertically symmetric with respect to the data driving circuit and connected to the gate pad groups for supplying scanning signals to drive the gate lines, and a FPC film for supporting the gate and data driving circuits.

In another aspect of the present invention, a timing controller for supplying timing control signals and data required for the gate and data driving ICs may be mounted on the FPC film.

In yet another aspect of the present invention, circuits for supplying control signals and data through the FPC film may be mounted on a main board and a connector may be arranged at an end of the FPC film and for connecting to a connection jack of the main board.

In still another aspect of the present invention, a gate low voltage may be supplied to a first gate line and controlled by the timing controller.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a plan view of a liquid crystal display module in a portable information terminal;

FIG. 2 illustrates a plan view of the arrangement of lines connected to a pad group of the liquid crystal display shown in FIG. 1; and

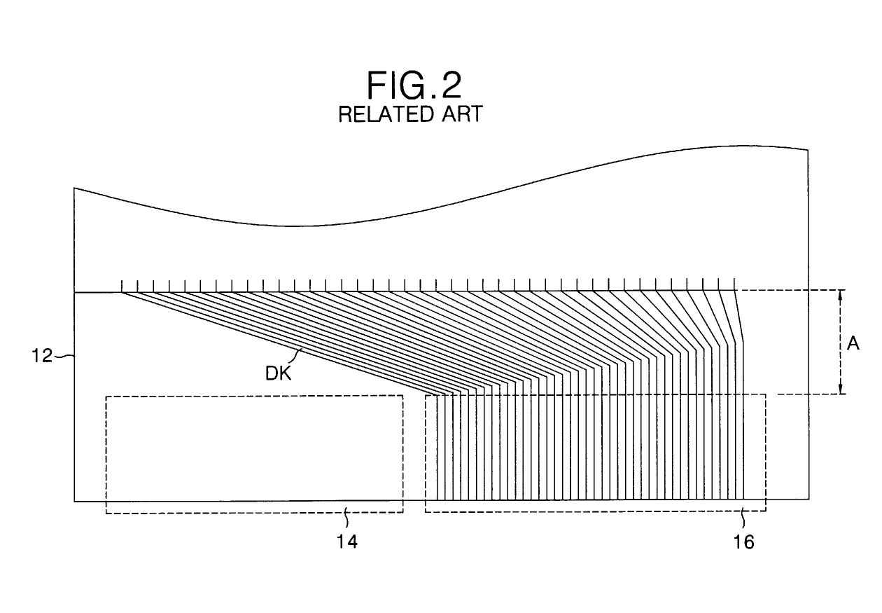

FIG. 3 illustrates a plan view of a liquid crystal display module in a portable information terminal in accordance with an embodiment of the present invention.

### DETAILED DESCRIPTION OF THE ILLUSTRATED EMBODIMENTS

Reference will now be made in detail to an embodiment of the present invention, example of which is illustrated in the accompanying drawings.

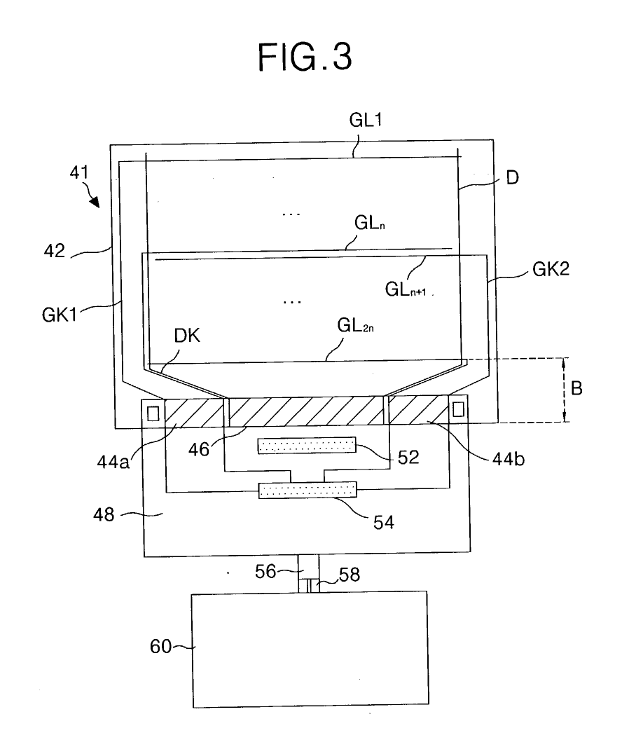

FIG. 3 illustrates a plan view of a liquid crystal display module in accordance with an embodiment of the present invention.

Referring to FIG. 3, an LCD module according to one aspect of the present invention may, for example, include a data pad group 46 arranged at a middle portion of an of a liquid crystal display panel 41 and first and second gate pad group 44a and 44b, respectively, arranged adjacent opposite portions of the data pad group 46.

According to the principles of the present invention, the LCD module may further include a plurality of gate driving ICs 54 and a plurality of data driving ICs 52 mounted on a first FPC film 48. The LCD module may still further include a second FPC film 56 for electrically connecting the first FPC film 48 to a main board 60.

In one aspect of the present invention, the liquid crystal display panel 41 may include a plurality of liquid crystal cells arranged in a matrix pattern at crossings of a plurality of gate lines GL and a plurality of data lines DL. Liquid crystal material may be provided between upper and lower substrates (not shown) that are bonded together. The upper substrate may support a sequentially formed color filter, a common electrode, and an alignment film. The lower substrate 42 may support sequentially formed thin film transistors TFTs, pixel electrodes, and an alignment film.

Gate pad groups 44a and 44b and data pad group 46 may be formed at a middle portion of an edge of the liquid crystal display panel 41. The gate pad groups 44a and 44b may be arranged at opposite portions of the data pad 46. Gate pads within the first gate pad group 44a may be connected to gate lines GL via a first gate link GK1 arranged at a left portion of the liquid crystal display panel 41. Gate pads within the second gate pad group 44b may be connected to gate lines GL via a second gate link GK2 arranged at a right portion of the liquid crystal display panel 41. Data pads within the data pad group may be connected to corresponding ones of data lines DL.

In one aspect of the present invention, 2n gate lines GL may be arranged on the liquid crystal display panel 41. Accordingly, gate pads within the first gate pad group 44a may be consecutively connected to the first to n^{th} gate lines while gate pads within the second gate pad 44b may be consecutively connected to the (n+1 )^{th} to 2n^{th} gate lines GL. In another aspect of the present invention, consecutive gate lines GL arranged on the liquid crystal display panel 41 may be alternately connected to gate pads within the first and second gate pad groups 44a and 44b, respectively.

In accordance with the principles of the present invention, the width B of the first and second gate links GK1 and GK2 may be reduced even when the resolution of the liquid crystal display panel 41 is increased. Accordingly, a compact LCD module may be realized.

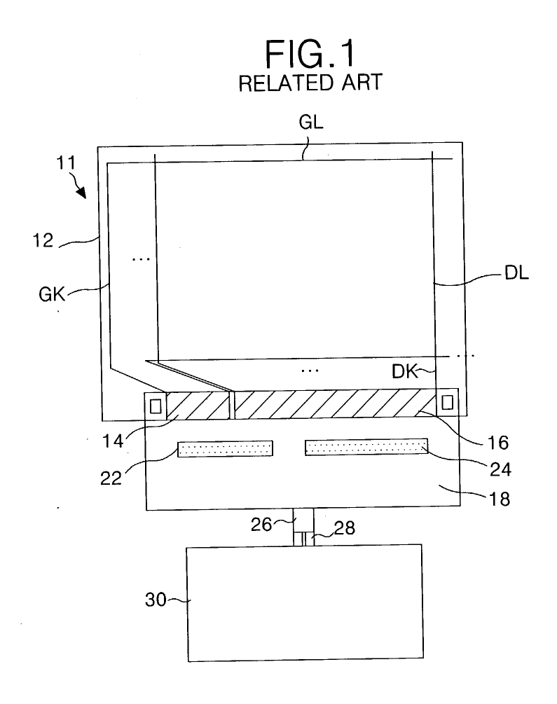

In one aspect of the present invention, the first and second gate pad groups 44a and 44b, respectively, may be substantially the same size and connected to the gate lines GL at left and right portions of the liquid crystal display panel 41, respectively. Further, a black matrix may be symmetrically formed at left and right sides of the liquid crystal display panel 41, unlike black matrices formed in liquid crystal display panels such as those illustrated in FIG. 1.

In one aspect of the present invention, output pads of the FPC film 48 may be coupled to the first and second gate pad groups 44a and 44b and the data pad group 46 using an anisotropic conductive film (ACF). The gate and data driving ICs 54 and 52, respectively, may be mounted on the FPC film 48 using a chip-on-film (COF) technique.

In another aspect of the present invention, the gate driving ICs 54 may generate scanning signals that to be sequentially supplied to the gate lines GL via the output pads of the FPC film 48. Accordingly, the liquid crystal display panel may be sequentially scanned by the scanning signals, one gate line at a time.

In another aspect of the present invention, the gate driving ICs 54 may be arranged under, and vertically symmetric with respect to, the data driving ICs 52. Further, the gate driving ICs 54 may be connected to the first and the second gate pad groups 44a and 44b, respectively. The number of conductive lines connecting the gate driving ICs 54 to the first gate pad group 44a may be the same as the number of lines connecting the gate driving ICs 54 to the second gate pad group 44b. Scanning signals sequentially outputted from the gate driver ICs 54 may be applied to the 1^{st} to the n^{th} gate lines GL1 to GLn via the first gate pad group 44a and the first gate link GK1 and applied to the (n+1)^{th} to the 2n^{th} gate lines GLn+1 to GL2n via the second gate pad group 44b and the second gate link GK2.

In one aspect of the present invention, a gate low voltage Vgl may be applied to the first gate line GL1. In another aspect of the present invention, the gate low voltage may be inputted to a storage capacitor (not shown). Voltages applied to the first gate line GL1 may be controlled using a timing controller (not shown) mounted on the FPC film 48. In another aspect of the present invention, the gate low voltage may be supplied without passing through the gate or data driving ICs 54 or 52, respectively. In one aspect of the present invention, a common voltage Vcom may be supplied to an electrode arranged on the upper substrate. In another aspect of the present invention, the common voltage may be controlled by the timing controller.

According to the principles of the present invention, the data driving ICs 52 may be arranged in correspondence with the data pad group 46 and supply video data signals to the data lines DL one data line at a time. Accordingly, a liquid crystal pixel cell connected to a scanned gate line may be charged with video data.

In one aspect of the present invention, a timing controller for controlling the gate and data driving ICs 54 and 52, respectively, may be mounted on the FPC film 48. The timing controller may include a shift register for supplying gate start pulses to of the each gate driving ICs 54 and red (R), green (G), and blue (B) data and clock signals to each of the data driving ICs 52.

In one aspect of the present invention, the FPC film 56 may include a signal transmission path through which electrical signals may be transmitted between the main board 60 and the driving FPC film 48. A connector 58 may be installed at an end of the FPC film 56 to a connection jack of the main board 60.

The main board 60 may, for example, include a microprocessor and a graphic processing circuit and supply video and control signals through the FPC film 56.

As described above, the portable information terminal incorporating a liquid crystal display includes a gate pad that is substantially equally divided and arranged adjacent opposite portions of a data pad. As a result, an area occupied by gate links for connecting gate pads to corresponding gate lines is minimized and the size of the portable information terminal may be reduced. Further, a line resistance within the gate link of the present invention may be reduced and picture distortion within the LCD module may be prevented. Moreover, the black matrix of the present invention may be symmetrically arranged on the liquid crystal display panel.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A portable information terminal incorporating a liquid crystal display, comprising:
a liquid crystal display panel including a plurality of gate lines and a plurality of data lines;
a data pad group formed at a middle portion of a liquid crystal display panel, the data pad group including a plurality of data pads, wherein each of the plurality of data pads is connected to a corresponding one of the plurality of data lines; and
a plurality of gate pad groups arranged adjacent opposite portions of the data pad group, wherein the plurality of gate pad groups each include a plurality of gate pads, wherein each of the plurality of gate pads are connected to a corresponding one of the plurality of gate lines.

2. The portable information terminal according to claim 1, further comprising:
a data driving integrated circuit for supplying video data to the data lines and for driving the plurality of data lines;
a gate driving integrated circuit arranged vertically symmetric with respect to the data driving integrated circuit and connected to the plurality of gate pad groups for supplying scanning signals to the plurality of gate lines; and
a flexible printed circuit film on which the gate and data driving integrated circuits are mounted.

3. The portable information terminal according to claim 2, further comprising a timing controller mounted on the flexible printed circuit film for supplying timing control signals and data required by gate and data driving integrated circuits.

4. The portable information terminal according to claim 2, further comprising:
a main board on which are mounted circuits for supplying control signals and data to the flexible printed circuit film; and
a connector installed at the end of the flexible printed circuit film and connected to a connection jack of the main board.

5. The portable information terminal according to claim 3, wherein a gate low voltage for being applied to a first gate line is controlled by the timing controller.

6. A liquid crystal display module, comprising:
a liquid crystal panel including a plurality of gate lines and a plurality of data lines;
a plurality of data pads coupled to corresponding ones of the plurality of data lines;
a plurality of gate pads coupled to corresponding ones of the plurality of gate lines;
a data driving integrated circuit, coupled to the plurality of data pads; and
a gate driving integrated circuit arranged vertically symmetric with respect to the data driving integrated circuit, coupled to the plurality of gate pads.

7. The liquid crystal display module according to claim 6, wherein an equal number of the plurality of gate pads are arranged at opposite portions of the plurality of data pads.

8. The liquid crystal display module according to claim 6, wherein
the plurality of gate pads are provided in a first group and a second group;
a first consecutive grouping of the plurality of gate lines are coupled to the plurality of gate pads within the first group; and
a second consecutive grouping of the plurality of gate lines are coupled to the plurality of gate pads within the second group.

9. The liquid crystal display module according to claim 6, wherein
the plurality of gate pads are provided in a first group and a second group;
a first alternating grouping of the plurality of gate lines are coupled to the plurality of gate pads within the first group; and
a second alternating grouping of the plurality of gate lines are coupled to the plurality of gate pads within the second group.

10. The liquid crystal display module according to claim 6, further comprising a flexible circuit film for supporting the gate and data driving integrated circuits.

11. The liquid crystal display module according to claim 10, further comprising a main board for supporting mounted circuits for supplying control signals and data to the flexible printed circuit film.

12. A liquid crystal display module, comprising:
a liquid crystal panel including a plurality of gate lines and a plurality of data lines;
a plurality of data pads coupled to corresponding ones of the plurality of data lines; and
a plurality of gate pads coupled to corresponding ones of the plurality of gate lines, wherein a first group of the plurality of gate lines is coupled to a first group of the plurality of gate pads at a first side of the liquid crystal panel, and wherein a second group of the plurality of gate lines is coupled to a second group of the plurality of gate pads at a second side of the liquid crystal panel.

13. The liquid crystal display module according to claim 12, wherein the first side of the liquid crystal panel is opposite the second side of the liquid crystal panel.

14. The liquid crystal display module according to claim 12, wherein the first group of gate lines includes a plurality of consecutively arranged gate lines.

15. The liquid crystal display module according to claim 12, wherein the first group of gate lines includes a plurality of alternately arranged gate lines.

16. The liquid crystal display module according to claim 12, wherein the first group of the plurality of gate pads is arranged at a first side of the plurality of data pads and the second group of the plurality of gate pads is arranged at a second side of the plurality of data pads.

17. The liquid crystal display module according to claim 16, wherein the first side of the plurality of data pads is opposite the second side of the plurality of data pads.
